(19) United States
(12) Patent Application Publication
(10) Pub. No.: US 2007/0039303 A1
(43) Pub. Date: Feb. 22, 2007

(54) Auxiliary hydraulic system

(76) Inventor: James D. Mitchell JR., (US)

Correspondence Address: James D. Mitchell Jr., 3800 Coopers Mountain Road, Martinsville, VA, 24112, US

(21) Appl. No.: 11/504,862

(22) Filed: Aug. 16, 2006

Related U.S. Application Data
(60) Provisional application No. 60/709,547, filed on Aug. 19, 2005.

(51) Int. Cl. A01D 34/00

(52) U.S. Cl. 56/14.7

(57) ABSTRACT

An auxiliary hydraulic system for zero turn radius lawnmowers or lawn tractors that is used to power attachments that require a rotating shaft for their power source. The attachments perform task other than just the cutting of the vegetation that the base unit passes over, such as trimming, edging, blowing of debris, vacuuming and etc. The auxiliary hydraulic system will give the operator of the base unit control of engaging or disengaging the operation of attachments and control over the speed of the attachments from the seat of the base unit. The auxiliary hydraulic system will allow for rapid mounting and dismounting of attachments to the base unit. The auxiliary hydraulic system will provide a power source that can be easily diverted from one attachment to another. The auxiliary hydraulic system will make the use of attachments on zero turn radius lawn mowers or lawn tractors more compact, more user friendly, more cost effective, more productive and more labor saving,

### CROSS REFERENCE TO RELATED APPLICATION

This application claims priority from U.S. provisional application Ser. No. 60/709,547 filed Aug. 19, 2005

### BACKGROUND OF THE INVENTION

This invention relates to an auxiliary hydraulic system that is used to power an attachment, that requires a constant rotation of a shaft, either clockwise or counter clockwise, for its power source. The attachment is either mounted or attached and is used to perform tasks other than just cutting vegetation that the mowers on zero turn radius lawn mowers or lawn tractors pass directly over.

### DESCRIPTION OF THE RELATED ART

In the lawn care industry today there are many tasks other than mowing to be done. Trimming, edging, blowing of debris from areas, vacuuming unwanted clippings and debris and numerous other task are required. These task are accomplished by hand operated equipment or attachments that are mounted on zero turn radius lawn mowers or lawn tractors.

As of today's technology the attachments mounted on zero turn radius lawn mowers or lawn tractors are either powered from the base unit by belts or have their own separate engines. The use of either of these two sources of power to operate attachments causes the attachments to be time consuming to install and sometimes causes the attachments to be bulky and awkward in size. It also restricts the amount of control that the operator has over the attachment from the seat of the base unit.

When using hand held, hand operated equipment a job with multiple task requires another person or persons other than the operator of the zero turn radius lawn mower or lawn tractor to perform other task while the operator of the base unit is mowing. Or the operator of the base unit must go back and perform other task after mowing task is done. This adds more labor and requires more time to do the job.

The use of hydraulics is not a new technology. The application described here for the use of hydraulics to power auxiliary attachments that require a constant rotation of a shaft, either clockwise or counter clockwise, for its source of power on zero turn radius lawn mowers or lawn tractors is new. The hydraulic systems that are in use today are used to either propel the base unit over the ground or to power the blades that cut the vegetation that the mowers on the base unit passes directly over or are used for a combination of both. The hydraulic systems of today are also used to raise and lower mower decks.

U.S. Pat. No. 3,918,240 describes a hydraulic system for a mower that powers the mowers that cut the vegetation that passes directly under the said mower and is also used to propel the said mower across the ground.

U.S. Pat. No. 3,992,858 describes a hydraulic system for powering the mowers that cut vegetation that passes directly under said mowers and powering the raising and lowering of the mowers deck.

U.S. Pat. No. 6,889,489 describes a machine with a hydraulic system used to power mower across the ground, raise and lower mower deck and again, power the blades that cut vegetation that the mowers on the base unit passes directly over.

The benefits of using an auxiliary hydraulic system to power attachments that require a continuous rotating of a shaft either clockwise or counter clockwise are many. The operator has complete control of the attachment from the seat of the base unit. The operator can engage or disengage the attachment at will, vary the speed of the attachment from the seat of the base unit. Convert the base unit from a single purpose machine to a multi purpose machine. Attachments can be mounted and dismounted very quickly. One or more functions can be preformed at the same time. The use of an auxiliary hydraulic system can dramatically reduce labor time and cost and reduce the cost of attachments that require the continuous rotating of a shaft for its power. The use of an auxiliary hydraulic system can eliminate the use of a second engine for attachments. The operator will be able to use the base unit alone when desired, use the attachment when desired or use both at the same time as desired. Or the operator can rotate back and forth to any combination as desired.

### SUMMARY OF THE INVENTION

An auxiliary hydraulic system for a zero turn radius lawn mowers or lawn tractors is described.

An auxiliary hydraulic system would be used to power attachments that require a continuous rotation of a shaft, either clockwise or counter clockwise, for its power source, that are mounted on a zero turn radius lawn mowers or lawn tractors used to perform functions other than cutting the vegetation that the lawn mowers or lawn tractors pass directly over, such as trimming, edging, blowing debris from areas, vacuuming and etc.

The auxiliary hydraulic system would be comprised of a reservoir that would hold the hydraulic oil in reserve and may or may not have a filtration system for hydraulic oil exiting the reservoir or returning to the reservoir. However a filtration system would be desirable.

The auxiliary hydraulic system would have a pump that draws its power from the engine of the base unit. The pump could be one pump or a plurality of pumps having the same capacity or different amounts of capacity. The pumps may or may not have a system for pressure relief. The pump or pumps could also be used to perform functions on the base unit such as propelling base unit over the ground, powering the blades that cut vegetation that the mowers on the base unit pass directly over or to raise and lower decks.

The hydraulic oil would travel from the reservoir to the pump or pumps through a rigid or a flexible line. Then from the pump or pumps to a valve body, through a rigid or a flexible line, the valve body having one port or a plurality of ports. Valves can be hand operated or have a solenoid to operate them. The valves may or may not have a pressure relief mechanism.

From the valve the oil supply would flow through a rigid or a flexible line to a flow control mechanism. The system having one or a plurality of flow control mechanisms.

From the flow control mechanisms the desired amount of oil would flow through a rigid or a flexible line, towards the motor of the attachment to be operated and the excess oil would return through a rigid or a flexible line to the reservoir.

The controls of the valves and the flow control mechanisms would be mounted to be user friendly to the operator.

The valve and the flow control mechanism can be individual units or be combined into a single unit, with or without a pressure relief.

On the hydraulic line that runs between the flow control and the motor on the attachment there would be a quick coupling that would connect or disconnect the hydraulic line. On the hydraulic line that returns the oil from the motor of the attachment to the reservoir there would also be a quick coupling that would connect or disconnect the hydraulic line. By installing these quick couplings in both lines it will aid in the rapid mounting and dismounting of attachments to the base unit. This would make the auxiliary hydraulic system a power source not designated for the operation of one machine, therefore the source of power used to continuously rotate a shaft could be readily and easily transferred from one attachment to another. These couplings will allow oil to pass through the lines when connected and retain oil in the lines when disconnected and will allow a very minimal loss of oil when connecting and disconnecting. There can be one set of quick connect couplings or a plurality of sets of quick connect couplings. By having a plurality of sets of quick connect couplings the operator would have the ability to operate one or more attachments at the same time to perform multiple task.

The auxiliary hydraulic system may or may not have a pressure relief mechanism, however it would be desirable to have a pressure relief mechanism. There are many places in the auxiliary hydraulic system that the pressure relief mechanism could be incorporated into. The pressure relief mechanism could be built into the pumps, the pressure relief mechanism could be incorporated into the hydraulic line anywhere between the pumps and the motor of attachment, the pressure relief mechanism could be built into the motor of the attachment. The pressure relief mechanism could be incorporated into the valve body or the pressure relief mechanism could be incorporated into the flow control mechanism.

The auxiliary hydraulic system may or may not have an oil cooling unit. However it would be desirable to have an oil cooling unit in the return line before the oil enters back into the reservoir.

An objective of this invention is to provide an auxiliary hydraulic system that is used to power attachments that require the continuous rotation of a shaft, either clockwise or counter clockwise for their power source, that mount to zero turn radius lawn mowers or lawn tractors. These attachments perform task other than just the cutting of the vegetation that mowers of the base unit pass directly over.

Another objective is to give the operator of the base unit more control or complete control of engaging or disengaging the operation of attachments and control over the speed of the attachments from the seat of the base unit.

Another objective is to convert the base unit from a single function machine into a multi function machine when desired.

Another objective is to have a power source that is used for the continuous rotation of a shaft, clockwise or counter clockwise, that can be easily diverted from one attachment machine to another attachment machine.

Another objective is to reduce time and labor cost that it takes to do multi task jobs in lawn maintenance.

Another objective is to make auxiliary attachments, that draw their power from a continuous rotating shaft, either clockwise or counter clockwise, that are used on zero turn radius lawn mowers or lawn tractors more compact, more user friendly, more cost effective, more productive and more labor saving.

### BRIEF DESCRIPTION OF THE DRAWINGS

FIG. 1. is a sketch of an auxiliary hydraulic system.

### ELEMENT LIST

1. Oil Reservoir
2. Hydraulic Pump
3. Control Valve
4. Flow Control Valve
5. Pressure Relief Valve
6. Quick Connect Coupling
7. Quick Connect Coupling
8. Oil Cooler Unit
9. Supply Line
10. Return Line
11. One Way Check Valve

### DETAILED DESCRIPTION OF THE INVENTION

This is a description of a drawing for an auxiliary hydraulic system for zero turn radius lawn mowers or lawn tractors. The drawing is a rough sketch to show the mechanical construction and functions of the auxiliary hydraulic system. The drawing is not to scale. The purpose of the auxiliary hydraulic system is to provide an auxiliary hydraulic system for attachments that require a continuous rotating shaft, either clockwise or counter clockwise, for its power source, that are mounted or attached on zero turn radius lawn mowers or lawn tractors. The drawing does not show any mounted applications of the auxiliary hydraulic system because the mounting applications will be numerous.

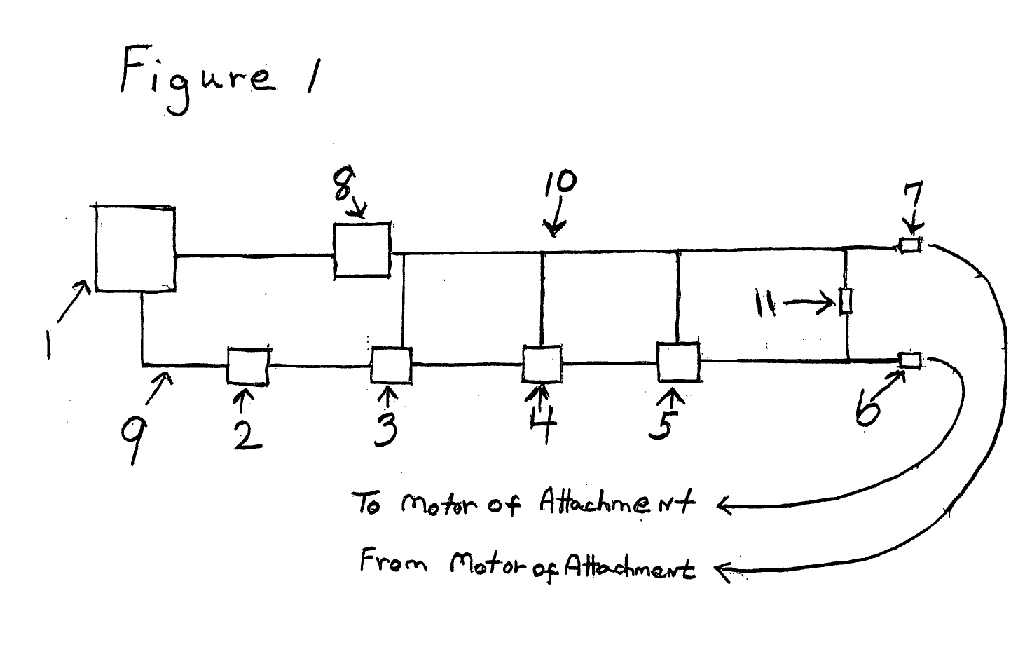

In FIG. 1 number one (1) is a hydraulic oil reservoir. Oil is stored and oil exits the reservoir number one (1) through supply line number nine (9) to the pump number two (2) and receives oil from return line number ten (10).

In FIG. 1 number (2) is the hydraulic pump. Hydraulic pump number two (2) receives oil from the reservoir number one (1) through the supply line number nine (9) and forces oil on toward the motor of the attachment of machine to be operated through supply line number nine (9)

In FIG. 1 number three (3) is the control valve. The control valve number three (3) intersects with the supply line number nine (9) between the pump number three (3) and the motor of the attachment to be operated. The control valve number three (3) can be controlled to direct the flow of oil onward toward the motor of the attachment to be operated or directed to return line number ten (10) back to the reservoir number one (1). Or the control valve number three (3) can be a valve that allows the pressurized hydraulic oil to flow towards the motor of the attachment to be operated or the control valve number three (3) can be switched to simultaneously direct the hydraulic oil through the return line number ten (10) back to the reservoir number one (1) and the supply line number nine (9) taking the path of least resistance.

In FIG. 1 number four (4) is the flow control valve. The flow control valve number four (4) intersects supply line number nine (9) between the pump number three (3) and the motor of the attachment to be operated. The flow control valve number four (4) allows the desired volume of oil to flow towards the motor of the attachment to be operated through the supply line number nine (9). If there is any excess volume of oil it flows through the return line number ten (10) to the reservoir number one (1).

In FIG. 1 number five (5) is the relief valve. The relief valve number five (5) intersects with the supply line number nine (9) between the pump number three (3) and the motor of the attachment to be operated. When hydraulic oil exceeds desired amount of pressure relief valve number five (5) routes oil to return line number ten (10) then to reservoir number one (1).

In FIG. 1 number six (6) is the quick connect coupling. The quick connect coupling number six (6) intersects the supply line number nine (9) between the pump number three (3) and the motor of the attachment to be operated. The quick connect coupling number six (6) is used to make the connection between pump number two (2) and the motor of the attachment to be operated or is used to sever the connection between the pump number two (2) and the motor of the attachment to be operated.

In FIG. 1 number seven (7) is the quick connect coupling. The quick connect coupling number seven (7) intersects the return line number ten (10) and is used to make the connection between the motor of the attachment and the reservoir number one (1) or to sever the connection between the motor of the attachment and the reservoir number one (1).

In FIG. 1 number eight (8) is the oil cooler unit. The oil cooler unit number eight (8) intersects return line number ten (10) between the motor of the attachment and the reservoir number one (1). The purpose of the oil cooler unit number eight (8) is to lower the temperature of the oil before it enters the reservoir number one (1).

In FIG. 1 number nine (9) is the supply line. The supply line number nine (9) transfers oil from the reservoir number one (1) to the motor of the attachment to be operated.

In FIG. 1 number ten (10) is the return line. The return line number ten (10) transfers oil from the motor of the attachment to be operated to the reservoir number one (1).

In FIG. 1 number eleven (11) is a one way check valve in a hydraulic line that makes a direct connection between the supply line number nine (9) and the return line number ten (10). The check valve number eleven (11) prohibits the flow of oil from the supply line number nine (9) to the return line number ten (10). The check valve number eleven (11) allows for the flow of oil from return line number ten (10) to supply line number nine (9). This will allow non pressurized hydraulic fluid to be available to the motor of the attachment that is being operated while the momentum of the attachment is being dissipated, keeping the motor of the attachment from running dry after the pressurized oil flow has been cut off. The auxiliary hydraulic system may or may not have a one way check valve number eleven (11).

What is claimed is:

1. An auxiliary hydraulic system for a zero turn radius lawn mowers or lawn tractors that is used to power attachments that require the continuous rotation of a shaft for its power source, that are mounted or attached permanently or temporarily to zero turn radius lawn mowers or lawn tractors. Said attachments are used to perform task other than the mowing of the vegetation that passes directly under the zero turn radius lawn mowers or lawn tractors. Comprising of:
a reservoir for the storage of hydraulic fluid.
a hydraulic pump drawing its power from the base unit it is mounted on that forces the hydraulic fluid towards the motor of the attachment to be operated.
a set of hydraulic lines, one routing the pressurized hydraulic fluid toward the motor of the attachment to be operated and the other returning hydraulic fluid to the reservoir from the motor of attachment to be operated.
a control valve that intersects the pressurized hydraulic line, that directs the pressurized hydraulic fluid toward the motor of the attachment to be operated or directs the hydraulic fluid simultaneously toward the reservoir or the motor on the attachment being operated allowing the pressurized fluid to take the path of least resistance.
a flow control valve that intersects the pressurized hydraulic line that routes the desired amount of pressurized fluid to the motor of the attachment to be operated and if there is any excess fluid the flow control valve routes it back to the reservoir.
a pressure relief valve that intersects the pressurized hydraulic line. When exceeding desired pressure for the operation of the hydraulic system the pressure relief valve will route hydraulic fluid to reservoir.
a one way check valve connected on one end to the pressurized hydraulic line, on the other end connected to the return hydraulic line, that returns fluid to the reservoir, prohibiting the flow of hydraulic oil from the pressurized hydraulic line to the return line and allowing the flow of hydraulic oil from the return line to the pressurized line
a set of quick connect couplings, one coupling severs or connects the pressurized hydraulic line to the motor of the attachment to be operated, the other quick connect coupling severs or connects the return hydraulic line from the motor of the attachment to be operated to the reservoir.
an oil cooling unit that intersects the return hydraulic line.
all components are hydraulically connected.

2. An auxiliary hydraulic system set forth in claim 1 wherein the pump is either a single pump or a plurality of pumps having equal capacity or unequal capacity.

3. An auxiliary hydraulic system set forth in claim 1 wherein the control valve has a single port or a plurality of ports.

4. An auxiliary hydraulic system set forth in claim 1 wherein the flow control valve is a single valve or a plurality of valves.

5. An auxiliary hydraulic system set forth in claim 1 wherein the control valve, the flow control valve and the pressure relief valve can be single units or can be incorporated into one unit.

6. An auxiliary hydraulic system set forth in claim 1 wherein the pressure relief valve can be incorporated into the pump or the motor of the attachment to be operated.

7. An auxiliary hydraulic system set forth in claim 1 wherein the control valve and the flow control valve can be incorporated into a single unit.

8. An auxiliary hydraulic system set forth in claim 1 wherein the control valve and the relief valve control can be incorporated into a single unit.

9. An auxiliary hydraulic system set forth in claim 1 wherein the flow control valve and the pressure relief valve can be incorporated into a single unit.

10. An auxiliary hydraulic system set forth in claim 1 wherein the set of quick connect couplings are a single set or a plurality of sets.

11. An auxiliary hydraulic system for a zero turn radius lawn mower or lawn tractors that is used to power attachments that require the continuous rotation of a shaft for its power source, that are mounted or attached permanently or temporarily to zero turn radius lawn mower or lawn tractors. Said attachments are used to perform task other than the mowing of the vegetation that passes directly under the zero turn radius lawn mower or lawn tractor. Comprising of:
a reservoir for the storage of hydraulic fluid.
a hydraulic pump drawing its power from the base unit it is mounted on that forces the hydraulic fluid towards the motor of the attachment to be operated.
a set of hydraulic lines, one routing the pressurized hydraulic fluid toward the motor of the attachment to be operated and the other returning hydraulic fluid to the reservoir from the motor of attachment to be operated.
a control valve that intersects the pressurized hydraulic line, that directs the pressurized hydraulic fluid toward the motor of the attachment to be operated or directs the hydraulic fluid to the reservoir.
a flow control valve that intersects the pressurized hydraulic line that routes the desired amount of pressurized fluid to the motor of the attachment to be operated and if there is any excess fluid the flow control valve routes it back to the reservoir.
a pressure relief valve that intersects the pressurized hydraulic line. When exceeding desired pressure for the operation of the hydraulic system the pressure relief valve will route hydraulic fluid to reservoir
a set of quick connect couplings, one coupling severs or connects the pressurized hydraulic line to the motor of the attachment to be operated, the other quick connect coupling severs or connects the return hydraulic line from the motor of the attachment to be operated to the reservoir.
an oil cooling unit that intersects the return hydraulic line.
all components are hydraulically connected.

12. An auxiliary hydraulic system set forth in claim 11 wherein the pump is either a single pump or a plurality of pumps having equal capacity or unequal capacity.

13. An auxiliary hydraulic system set forth in claim 11 wherein the control valve has a single port or a plurality of ports.

14. An auxiliary hydraulic system set forth in claim 11 wherein the flow control valve is a single valve or a plurality of valves.

15. An auxiliary hydraulic system set forth in claim 11 wherein the control valve, the flow control valve and the pressure relief valve can be single units or can be incorporated into one unit.

16. An auxiliary hydraulic system set forth in claim 11 wherein the pressure relief valve can be incorporated into the pump or the motor of the attachment to be operated.

17. An auxiliary hydraulic system set forth in claim 11 wherein the control valve and the flow control valve can be incorporated into a single unit.

18. An auxiliary hydraulic system set forth in claim 11 wherein the control valve and the relief valve control can be incorporated into a single unit.

19. An auxiliary hydraulic system set forth in claim 11 wherein the flow control valve and the pressure relief valve can be incorporated into a single unit.

20. An auxiliary hydraulic system set forth in claim 11 wherein the set of quick connect couplings are a single set or a plurality of sets.
